(19) United States
(12) Patent Application Publication
(10) Pub. No.: US 2009/0126849 A1
(43) Pub. Date: May 21, 2009

(54) Tire for a heavy vehicle

(76) Inventor: Pierre Durif, Enval (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/920,758

(22) PCT Filed: May 16, 2006
(86) PCT No.: PCT/EP2006/062335

§ 371 Date: Nov. 19, 2007

(30) Foreign Application Priority Data
May 18, 2005 (FR) 0505057

(51) Int. Cl. B60C 15/00; B60C 9/08; B60C 9/09

(52) U.S. Cl. 152/554

(57) ABSTRACT

A tire for a heavy vehicle, comprising a radial carcass reinforcement surmounted radially by a working crown reinforcement, the carcass reinforcement comprising at least one ply of reinforcing members which is anchored in each of the beads by being wrapped around a bead wire in order to form a ply turn-up. The radially outer end of the ply turn-up is at a distance from the radially outer part of the bead wire of less than 40% of the height of the sidewall, said tire includes at least one complementary ply of radially oriented reinforcing members having compressive and tensile moduli at least 1.5 times lower than those of the carcass reinforcement ply, and said complementary ply is axially adjacent to the ply turn-up of the carcass ply over a distance greater than 15% of the height of the sidewall.

The invention relates to a tire with a radial carcass reinforcement, intended for fitting onto a heavy vehicle such as a transport vehicle or a “civil engineering” vehicle.

Although not limited to this type of application, the invention will be more particularly described with reference to a tire having an axial width greater than 37 inches.

Such a tire, generally intended for supporting heavy loads, includes a radial carcass reinforcement and a crown reinforcement both composed of at least two working crown plies that are formed from inextensible reinforcing members, crossed from one ply to the next and making equal or unequal angles, of between 10° and 45°, to the circumferential direction.

Such tires, usually manufactured by “conventional” processes, have anchoring members such as bead wires used for the anchoring or retention of the carcass reinforcement in the bead zone of the tire. At least one carcass ply constituting the carcass reinforcement has a portion turned up around a bead wire placed in the bead of the tire. In this way, the carcass reinforcement is anchored in the bead.

The radial carcass reinforcement is subjected to high stresses, especially during inflation of the tire and then during its use. These stresses generate shear, especially radial shear stresses. These stresses are firstly due to the inflation pressure of the tire, which tends to cause said crown reinforcement to expand circumferentially. Thereafter, said stresses are due to the load supported by the tire and to the rolling deformations owing in particular to the tread passing into the contact area or contact surface between the ground and the tire. These stresses result in the appearance of cracks in the rubber compounds, which cracks propagate in said compound and degrade the endurance of the tire.

An improvement in endurance may be obtained in the case of heavy vehicle tires by a greater length of the carcass ply turn-up around the bead wire. Specifically, it is known to produce tires in which the ply turn-up length is increased and in particular extends as far as a position such that, when passing into the zone of the contact area, the end of said ply turn-up lies substantially in the zone with the largest axial width of the carcass ply in a radial cross section of a tire under nominal use conditions. The results obtained with this type of design show that the rubber compounds in which cracks were observed owing to the radial shear stresses between the carcass ply and its portion turned up around the bead wire are effectively protected from these impairments. The coupling over a larger distance of the carcass ply and of its ply turn-up actually reduces the shear stresses induced in the separating rubber compounds. Furthermore, the position of the end of the ply turn-up in a zone in which the shear stresses are at minimum makes it possible to limit the risk of cracking at the ends of said carcass ply turn-up.

In the case of heavy-vehicle tires having especially an axial width greater than 37 inches, the length of the ply turn-up becomes greater and naturally increases with the size of the tire. It follows that the coupling zone between the turn-up portion and the carcass ply is greater and seems to be the cause of the start of impairment of the reinforcing members that may be observed in certain types of use of the tire. This effect may be explained in particular by said reinforcing members being put into compression in the bearing zone on the rim gutter of the wheel onto which the tire is fitted.

The term “axial” is understood to mean a direction parallel to the rotation axis of the tire and “radial” is understood to mean a direction cutting the rotation axis of the tire perpendicularly to it. The rotation axis of the tire is the axis about which it rotates in normal use. The circumferential mid-plane is a plane perpendicular to the rotation axis of the tire, dividing the tire into two parts. A radial plane is a plane that contains the rotation axis of the tire.

In their studies, and especially during studies on producing tires of larger dimensions, especially with an axial width of greater than 37 inches, the inventors were given the objective of obtaining satisfactory endurance in tires for heavy vehicles.

This objective was achieved according to the invention by a tire for a heavy vehicle, comprising a radial carcass reinforcement surmounted radially by a working crown reinforcement, the carcass reinforcement comprising at least one ply of reinforcing members which is anchored in each of the beads by being wrapped around a bead wire in order to form a ply turn-up, the radially outer end of the ply turn-up being at a distance from the radially outer part of the bead wire of less than 40% of the height of the sidewall, said tire including at least one complementary ply of radially oriented reinforcing members having compressive and tensile moduli at least 1.5 times lower than those of the carcass reinforcement ply, and said complementary ply being axially adjacent the ply turn-up of the carcass ply over a distance greater than 15% of the height of the sidewall.

The sidewall height is defined according to the invention as a distance along the radial direction between the radial outer part of the bead wire and the radially outermost point of the carcass ply in the inflated state under nominal conditions.

The tire thus defined according to the invention was subjected to rolling tests followed by analysis of said tire, which demonstrated that the endurance of such a tire is improved. This is because the tire according to the invention, which has a shorter carcass ply turn-up length than in the normal practice, as described above, prevents the reinforcing members making up the carcass ply from being put into compression in the bearing zone on the rim gutters. Furthermore, it turns out that the presence of at least one complementary ply as described according to the invention makes it possible to limit the appearance and/or propagation of cracks, especially those due to shear stresses in the rubber compounds, in particular in the carcass ply turn-up zone.

According to a preferred embodiment of the invention, the radially outer end of the ply turn-up is at a distance from the radially outer part of the bead wire of greater than 15% of the height of the sidewall. Such a configuration is particularly preferable for limiting the amplitude of the stresses appearing at the ends of the carcass ply turn-ups.

Also preferably, the radially outer end of the ply turn-up is at a distance from the radially outer part of the bead wire of less than 35% of the height of the sidewall.

In an advantageous variant of the invention, the reinforcing members of at least one complementary ply are resilient metal reinforcing members.

The resilient metal reinforcing members are cables having a relative elongation at break of at least 4%.

The trials carried out have shown that the tires produced according to this variant of the invention have even greater endurance. The resilient nature of the reinforcing members seems to further decrease the shear stresses induced in the rubber compounds.

Even more preferably according to the invention, the radially inner end of the complementary ply is axially to the outside of the carcass ply turn-up. According to this preferred embodiment of the invention, the complementary ply is adjacent to the carcass ply turn-up and positioned axially to the outside of said ply turn-up. Such embodiments have shown, in particular in the case of resilient reinforcing members, that the appearance of cracks is further reduced, especially in the rubber compounds axially to the outside of the carcass ply turn-up.

According to other embodiments of the invention, the tire includes at least one complementary ply sandwiched between the carcass ply and its turn-up in the radially inner part of said complementary ply.

According to an alternative embodiment of the invention, the tire having two complementary plies, at least one complementary ply is axially internal to the carcass ply turn-up. Such a tire produced according to the invention will advantageously have one complementary ply on each side of the carcass ply turn-up in the axial direction.

Also advantageously according to the invention, the radially outer end of the complementary ply is at a distance from the radially outer part of the bead wire of greater than 50% of the height of the sidewall. A complementary ply of a tire produced according to this variant of the invention also results in a reduction in the stresses that may appear in the rubber compounds. Furthermore, the metallic nature of the reinforcing members of the complementary ply allows heat to be removed from the tire bead zone to the sidewall zone, in which zone the rubber compound thicknesses are more favorable to heat extraction. Complementary plies extending as far as the tire shoulder zones also have a similar thermal effect for extracting the heat appearing in said tire shoulder zones.

Such a tire as defined above according to the invention, that is to say one having a carcass ply turn-up of shorter length than that of a usual tire associated with a complementary ply extending into the sidewall of the tire, makes it possible to improve the endurance of heavy vehicle tires. Indeed, it appears that the tire according to the invention prevents the appearance of compressive stresses in the reinforcing members of the carcass ply turn-up, while maintaining control of the appearance of shear stresses in the rubber compounds.

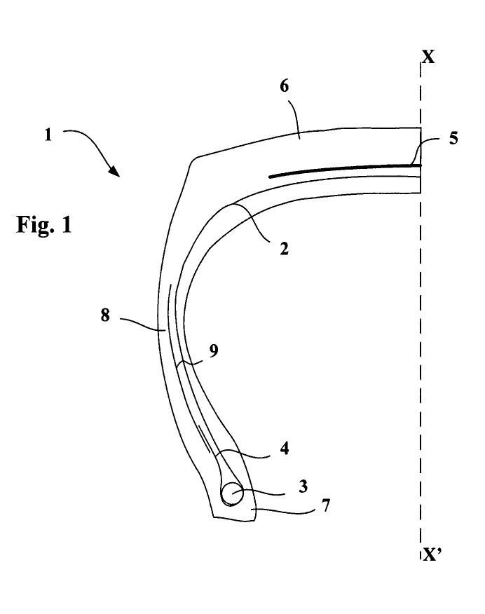

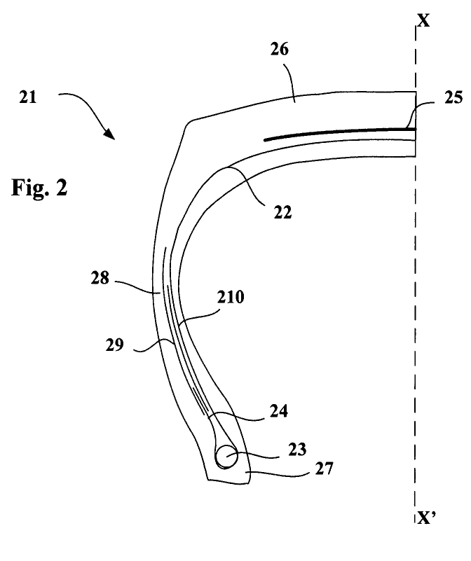

Other details and advantageous characteristics of the invention will emerge hereafter from the description of exemplary embodiments of the invention with reference to FIGS. 1 and 2, which show:

FIG. 1, a schematic partial representation of a tire seen in a radial sectional view according to a first embodiment of the invention; and

FIG. 2, a schematic partial representation of a tire seen in a radial sectional view according to a second embodiment of the invention.

The figures have not been drawn to scale in order to make them simpler to understand. The figures show only one half of the tire, which is extended symmetrically with respect to the XX′ axis, representing the circumferential mid-plane of a tire.

FIG. 1 shows schematically a radial cross section of a tire 1 normally used for civil engineering vehicles.

This tire 1 is a tire of 59/80 R 63 size.

This tire 1 comprises a carcass reinforcement 2 composed of a ply of inextensible metal cables, made of steel, anchored in each bead around a bead wire 3 to form a ply turn-up 4, the end of which, in accordance with the invention, lies substantially radially at a point internal to that of the largest axial width of the carcass reinforcement 2. The carcass reinforcement 2 is surmounted radially by a crown reinforcement 5. Said crown reinforcement 5 usually consists on the one hand of two working plies and, on the other hand, of two protective plies. All these plies constituting the crown reinforcement have not been shown in detail in the figures. The working plies themselves consist of inextensible steel cables, which are mutually parallel in each ply and crossed from one ply to the next, making angles that may range between 15° and 40° to the circumferential direction. The protective plies generally consist of metal cables, made of resilient steel, which are mutually parallel in each ply and crossed between them from one ply to the next, making angles that may range between 15° and 45°. The cables of the radially outer working ply are usually crossed with the cables of the radially inner protective ply. Finally, the crown reinforcement is surmounted by a tread 6, which is joined to the two beads 7 by the two sidewalls 8.

According to the invention, a complementary ply 9 is added to the carcass reinforcement. This complementary ply 9 consists of resilient metal cables of the E24×26 NF (non-hooped) type. On its radially inner part, it is axially adjacent to the carcass ply turn-up 4 and extends just into the sidewall of the tire. The radially outer end of the complementary ply 9 is at a distance from the radially outer part of the bead wire equal to 59% of the height of the sidewall.

In the tire produced as shown in FIG. 1, the radially outer end of the ply turn-up 4 is at a distance from the radially outer part of the bead wire equal to 33% of the height of the sidewall.

The complementary ply 9 is axially adjacent to the carcass ply turn-up over a distance equal to 32% of the height of the sidewall.

Compared to a standard tire, the radially outer end of the carcass ply turn-up 4 is at a smaller distance, in the radial direction, from the bead wire 3. The length of this carcass ply turn-up 4 is therefore shorter than in a tire of standard design.

Such an embodiment makes it possible in particular to prevent the reinforcing members of this ply turn-up 4 from being put into compression, especially when passing into the contact area zone.

The presence of the complementary ply 9 consisting of resilient metal cable members prevents the appearance of shear stresses in the rubber compounds, or at the very least limits the effect thereof on said compounds.

FIG. 2 shows schematically, in radial cross section, a second embodiment of a tire according to the invention. In this embodiment, the tire 21 has the same features as the tire 1 of FIG. 1, but the tire 21 also has a second complementary ply 210.

This second complementary ply 210 is placed axially between the first complementary ply 29 and the carcass ply 22. According to the case shown in FIG. 2, the radially inner part of said second complementary ply 210 is adjacent and axially to the inside of the ply turn-up 24 of the carcass ply 22.

The second complementary ply 210 is axially adjacent to the carcass ply turn-up 24 over a distance substantially equal to that over which the complementary ply 29 is adjacent to said ply turn-up 24, that is to say substantially equal to 32% of the height of the sidewall. The radially outer end of the complementary ply 210 is at a distance from the radially outer part of the bead wire equal to 55% of the height of the sidewall.

In the case of the tire shown in FIG. 2, the radially outer ends of the two complementary plies are at different radial positions. Such an embodiment advantageously makes it possible to limit the ply end effects, the ply 29 axially overlapping the radially outer end of the second complementary ply 210. In other embodiments according to the invention, the axially inner complementary ply may axially overlap the radially outer end of the axially outer complementary ply, again for the purpose of limiting the ply end effects.

These exemplary embodiments must not be interpreted in a limiting manner, there being many alternative embodiments. In particular, it is possible to provide an embodiment with a single complementary ply in the configuration of the ply 210. It is also possible to have a larger number of complementary plies. It is also conceivable to increase the length of the complementary plies, especially to obtain an effect on the thermal behavior of the tire shoulders, as mentioned above.

1. Tire for a heavy vehicle, comprising a radial carcass reinforcement surmounted radially by a working crown reinforcement, the carcass reinforcement comprising at least one ply of reinforcing members which is anchored in each of the beads by being wrapped around a bead wire in order to form a ply turn-up, wherein the radially outer end of the ply turn-up is at a distance from the radially outer part of the bead wire of less than 40% of the height of the sidewall, wherein said tire includes at least one complementary ply of radially oriented reinforcing members having compressive and tensile moduli at least 1.5 times lower than those of the carcass reinforcement ply, and wherein said complementary ply is axially adjacent the ply turn-up of the carcass ply over a distance greater than 15% of the height of the sidewall.

2. The tire according to claim 1, wherein the radially outer end of the ply turn-up is at a distance from the radially outer part of the bead wire of greater than 15% of the height of the sidewall.

3. The tire according to claim 1, wherein the radially outer end of the ply turn-up is at a distance from the radially outer part of the bead wire of less than 35% of the height of the sidewall.

4. The tire according to claim 1, wherein the reinforcing members of at least one complementary ply are resilient metal reinforcing members.

5. The tire according to claim 1, wherein the radially inner end of the complementary ply is axially to the outside of the carcass ply turn-up.

6. The tire according to claim 1, wherein the radially outer end of the complementary ply is at a distance from the radially outer part of the bead wire of greater than 50% of the height of the sidewall.

7. The tire according to claim 1, said tire comprising two complementary plies, wherein at least one complementary ply is axially internal to the carcass ply turn-up.
